(19) United States
(12) Patent Application Publication
(10) Pub. No.: US 2016/0224980 A1
(43) Pub. Date: Aug. 4, 2016

(54) CONFIGURABLE SYSTEM AND APPARATUS FOR RENDERING PAYMENT DECISIONS AND TRIGGERING ACTIONS

(71) Applicant: Kai STINCHCOMBE, San Francisco, CA (US)

(72) Inventor: Kai STINCHCOMBE, San Francisco, CA (US)

(21) Appl. No.: 15/017,434

(22) Filed: Feb. 5, 2016

Related U.S. Application Data
(63) Continuation of application No. 13/533,940, filed on Jun. 26, 2012.
(60) Provisional application No. 61/501,265, filed on Jun. 27, 2011.

(51) Int. Cl. G06Q 20/40; G06Q 20/42; G06Q 20/32

(52) U.S. Cl. CPC G06Q 20/401; G06Q 20/3255; G06Q 20/42

(57) ABSTRACT

According to an exemplary embodiment, a computer-implemented method of processing transactions initiated by a payer includes: providing administrative control that enables an administrator to specify predetermined transaction characteristics to be applied to subsequent electronic transactions; storing the predetermined transaction characteristics electronically; receiving an electronic payment authorization request submitted by a payee, the payment authorization request associated with a subsequent transaction initiated by the payer and having a set of submitted transaction characteristics; comparing the set of submitted transaction characteristics against the predetermined transaction characteristics; sending an approval or a denial of the payment authorization request to a payer fulfillment system on the basis of at least the results of the comparison.

### CROSS-REFERENCE TO RELATED APPLICATION

This application is a continuation of U.S. Non-Provisional patent application Ser. No. 13/533,940, filed on Jun. 26, 2012, which claims the benefit of U.S. Provisional Patent Application Ser. No. 61/501,265, filed on Jun. 27, 2011, both of which are entitled “Configurable System And Apparatus For Rendering Payment Decisions And Triggering Actions” and hereby incorporated by reference in their entirety.

### BRIEF DESCRIPTION

Embodiments of the present invention relate generally to a payment processing system. More specifically, a payment processing system including a method and apparatus for automatically rendering customer-configurable approval decisions and optionally triggering certain actions is provided.

### BACKGROUND

Increasingly, the elderly are able to live independently longer than in the past. While this independence is desirable for many reasons, it can leave the elderly, who may suffer from memory loss or difficulty with appropriate judgment, vulnerable to financial loss due to scams, or even just due to unwise spending habits. For instance, as the result of memory loss, an individual may forget that they had given money to a charity the day before, and may continue to give each day, beyond their means. In fact, there are many instances in which, because of age (old or young), cognitive impairment, addictions or other factors, the ability to appropriately manage financial transactions by an individual is impaired.

In the current state of the art, when a customer (payer) initiates a payment to a seller (payee) in a financial transaction, the seller usually submits the transaction to the customer's financial institution, for instance, the customer's bank or other institution where the payer has a deposit account or line of credit. The transaction may be submitted by the seller-payee to the financial institution via credit or debit card processing systems, for instance, by physical cards or proximity/mobile/electronic payment devices, such as the VIA® networks or the PULSE® network. Alternatively the transaction may be submitted to the financial institution via physical presentation of a check or presentation of an image of the check, via the Automatic Clearing House (ACH) for checks, or an “e-check” system. Various other payment fulfillments systems that act as intermediaries between the financial institution and the customer's source of funds or credit line at that institution, such as PayPal, may also be used.

Payments submitted to the financial institution are usually approved if there are sufficient funds available in the payer's account or credit line, and in some cases if the payment is within a certain specified amount, for instance, a cash limit withdrawal amount for a debit card. If there are not sufficient funds or the transaction is over limit, the transaction is denied. Additionally, a transaction may be denied due to “suspicious activity,” indicating possible fraud, in the payer's account. Such “suspicious activity” is typically identified based on the financially institution's own proprietary analytics systems. For example, the financial institution's proprietary system may identify that a large number of gas station transactions is an indicator that a payer's credit card has been lost or stolen, and is being used without the payer's authorization. In such a case, the financial institution, as an alternative to simply denying submitted transactions, may contact the payer directly and verify that the transactions were authorized, and if not, disables the means of access to the account—such as the credit or debit card—that was compromised.

### SUMMARY

In one aspect, a computer-implemented method for controlling a payment transaction from a payer to a payee is provided, the method including submitting a request for payment to a data processing machine, the request for payment including a set of submitted transaction characteristics for the payment transaction; and comparing, in the data processing machine, at least a portion of the set of submitted transaction characteristics to a set of predetermined transaction characteristics that are specific to the payer to determined a first payment decision for the payment transaction.

The method may further include allowing an authorized administrator of the payer to configure the set of predetermined transaction characteristics that are specific to the payer by accessing the data processing machine.

The predetermined transaction characteristics may include at least one of payee reputation, payee category, sale item category, number of transactions made by payer with the payee, amount of money spent by payer with the payee over a given period of time, geographic location of payee, geographic location of initiation of the payment transaction, and category limits.

The method may further include submitting the request for payment to a designated financial institution of the payer, wherein the designated financial institution provides an additional payment decision based on requirements of the designated financial institution, wherein the payment transaction is approved only if the first payment decision and the additional payment decision are approvals.

The method of may further include using the set of predetermined transaction characteristics that are specific to the payer to identify transaction characteristics needed for the payment decision and not included in the set of submitted transaction characteristics; and performing at least one of notifying the payee to request additional information, accessing stored payee information, and accessing stored payer information; and using at least one of the additional information, stored payee information and stored payer information to determine a complete set of submitted transaction characteristics needed for the payment decision.

In the method, comparing in the data processing machine, at least a portion of the set of submitted transaction characteristics to a set of predetermined transaction characteristics that are specific to the payer may include using a predetermined grouping system configured by an authorized administrator of the payer.

In the method, comparing, in the data processing machine, at least a portion of the set of submitted transaction characteristics to a set of predetermined transaction characteristics that are specific to the payer may include triggering the data processing machine to initiate a predetermined action configured by an authorized administrator of the payer.

The predetermined action may include notifying the authorized administrator of the request for payment.

In the method, comparing, in the data processing machine, at least a portion of the set of submitted transaction characteristics to a set of predetermined transaction characteristics that are specific to the payer includes obtaining authorization from the authorized administrator for the payment transaction.

The predetermined action may include requesting additional information from the payee.

The predetermined action may include notifying at least one of the payer and authorized administrator of the first payment decision.

The set of submitted transaction characteristics may include at least one of payee name, payee classification, payee location, payee sales items, items to be provided by payer to payee.

The method may further include alerting the data processing machine that a payer is in a geographical proximity to the payee; and triggering the data processing machine to initiate a predetermined action configured by an authorized administrator of the payer.

In another aspect, a computer-implemented method for making a payment decision from a payer to a payee is provided that includes configuring a set of configuration elements for the payer in a transaction control module, the configuration elements including a set of predetermined transaction characteristics, one or more predetermined grouping methods, and one or more predetermined actions each selected from a set of possible transaction characteristics, grouping methods and actions; using a payment system connected to the transaction control module to submit a payment request to the transaction control module, the payment request including a set of submitted transaction characteristics; and where the payment control module uses the configuration elements and the set of submitted transaction characteristics to render the payment decision, and communicate the payment decision to at least one of the payer or the payee when the payment decision is a denial.

The method may further include using the payment system to submit the payment request to a financial system of the payer, wherein the financial system provides an additional payment decision, wherein a payment from the payer to the payee is allowed only when the payment decision and the additional payment decision are both approvals.

The available transaction characteristics may include at least one of payee name, payee reputation, payee category, sale item category, number of transactions made by payer with the payee, amount of money spent by payer with the payee over a given period of time, geographic location of payee, geographic location of initiation of the payment transaction, and category limits.

In another aspect a system for approving or denying a payment from a payer is provided, the system including a processor; and a computer storage medium coupled the processor, the computer storage medium storing instructions that cause the processor to execute modules, the modules including an administrative control system module, the administrative control system module including a set of transaction characteristics, a set of grouping methods and a set of further actions; a configuration system module configured by an authorized administrator allowed to access the administrative control system module, the configuration system module including a set of predetermined transaction characteristics for the payer, one or more predetermined grouping methods for the payer, and one or more predetermined further actions for the payer; and a payment decision and action creator module connected to the configuration system, the payment decision and action creator module capable of receiving a request to approve or deny the payment, the request including a set of submitted transaction characteristics, the payment decision and action creator module using one or more of the predetermined grouping methods to compare the set of submitted transaction characteristics with the predetermined transaction characteristics for the payer to approve or deny the payment.

The set of transaction characteristics included in the administrative control system may include at least one of payee name, payee reputation, payee category, sale item category, number of transactions made by payer with the payee, amount of money spent by payer with the payee over a given period of time, geographic location of payee, geographic location of initiation of the payment transaction, and category limits.

The payment decision and action creator module may be capable of initiating the one or more predetermined further actions.

The payment decision and action creator module may be connected to a payments system module connected to a designated financial institution of the payer capable of providing an approval or denial of the payment based on payer account information with the designated financial institution.

The payee reputation is collected over time in the payment and decision and action creator module by use of the system by a group of prior users.

The set of submitted transaction characteristics may include at least one of payee name, payee classification, payee location, payee sales items, items to be provided by payer to payee.

### BRIEF DESCRIPTION OF THE FIGURES

FIG. 1 is an overview of a payment transaction using an example embodiment of the payment processing system.

FIG. 2 illustrates the administrator control system of the transaction control module.

FIG. 3A is a chart illustrating details of the payment processing system shown in FIG. 1.

FIG. 3B is a flow chart illustrating an example embodiment of a process used by the payment processing system.

FIG. 4A is an example embodiment of an apparatus for the administrative control system.

FIG. 4B is an example embodiment of an apparatus for making a transaction decision.

FIG. 5 depicts the elements of a transaction between payer and payee, and the places where, in various embodiments, the payment decision action server could be installed in order to operate the payment processing system.

### DETAILED DESCRIPTION

The current state of the art in payment processing, in which transactions are accepted or denied based simply on funds available, withdrawal limits, or identification of “suspicious activity” as determined by the financial institution, has several important drawbacks. First, only the three factors listed above—funds available, withdrawal limits, and identification of “suspicious activity”—are taken into account in make authorization decisions. Second, only certain actions are triggered in the system. Thus, the systems only alert payer's of problems in a limited number of circumstances, typically only when a balance rises or falls below a certain level or if the financial institution identifies a series of transactions it deems suspicious. Finally, and significantly, very limited customization or configuration is available. The factors taken into account in making authorization decisions are determined by the financial institution, and the payer has no control over which transactions will be authorized.

A method is needed that allows the financial accounts of individuals who, because of age (old or young), cognitive impairment, addictions, or other factors, may not able to appropriately manage their own financial transactions, to be managed in a way that is tailored to that individual. Such a method would prevent harmful financial losses while still allowing the individual to access their financial accounts, which will allow such individuals to live independently without the significant concerns that come with inability to manage finances.

Example embodiments of the payment processing system described herein address the limitations of the current state of the art payment processing and allow management and prevention of harmful financial loses. In particular, the payment processing system is highly customizable and configurable. Additionally, multiple factors may be taken into account in approving or denying transactions. Such factors may include, for example, the identity of the payee, whether the payee falls into certain categories, the payee's reputation, the time of day, whether the transaction was preapproved by a second authorized person, or a variety of other factors. Finally, multiple actions may be triggered when a transaction is initiated. Such actions may include, for example, text-messaging a designated recipient when transactions of a certain type are transmitted to the financial institution.

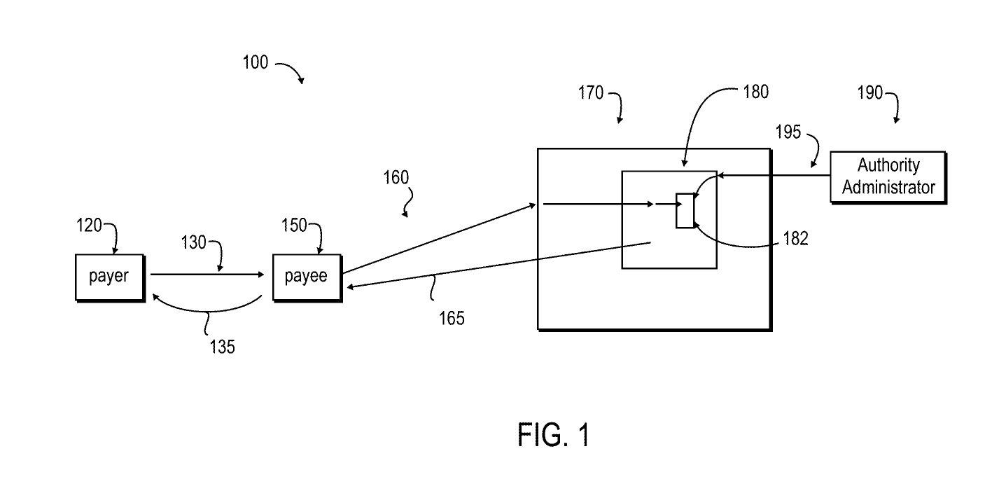

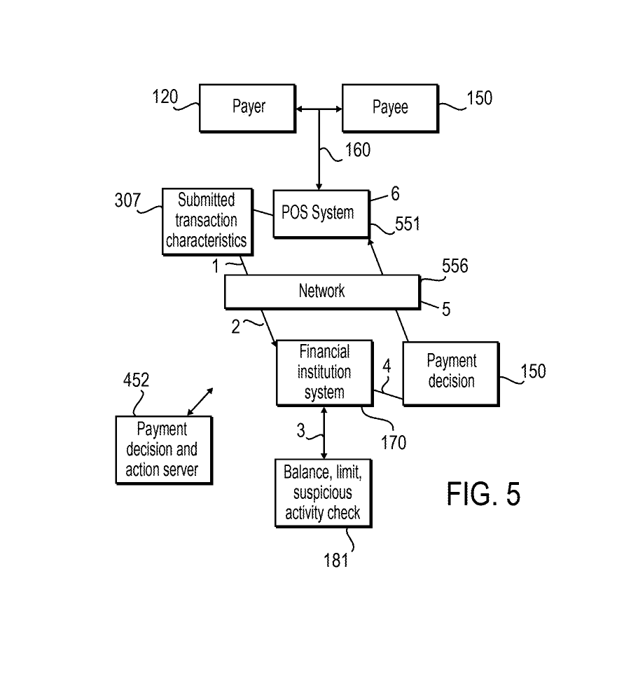

FIG. 1 is an overview of a payment transaction using an example embodiment of the payment processing system 100. A payer 12 initiates a payment transaction with a payee 150, and provides payee with necessary information 130 required for payee to submit a payment request 160 to the payee's financial institution 170. Such a payment request 160 can be submitted, via a transaction system, which will be described in more detail below with respect to FIG. 5, to a data processing machine 180 connected, either directly or indirectly, via the transaction system, to the payer's financial institution 170. The data processing machine 180 includes a transaction control module 182 that is configured specifically to the individual payer 12. Transaction control module 182 of data processing machine 180 is specifically configured 195 by an authorized administrator 190 using administrator controls via, for example, a secure data network that can access the data processing machine 180 and the transaction control module 182. Authorized administrator 190 is typically not someone who is an employee of the financial institution, but is more often a guardian, such as a relative, of the payer, or may even be the payer himself. As will be described in more detail below, a request for payment 160 sent to the transaction control module 182, includes a set of submitted transaction characteristics, which are certain data specific to the transaction. The submitted transaction characteristics are assessed against configuration elements of the transaction control module 182, which include predetermined transaction characteristics, set by the authorized administrator 190 in data processing machine 180. The results of the assessment invoke certain actions, as will be described in more detail below, one of which is to provide an authorization decision 165 to the payee. If authorization is provided, the payee provides the payer the goods or services 135 in exchange for payment.

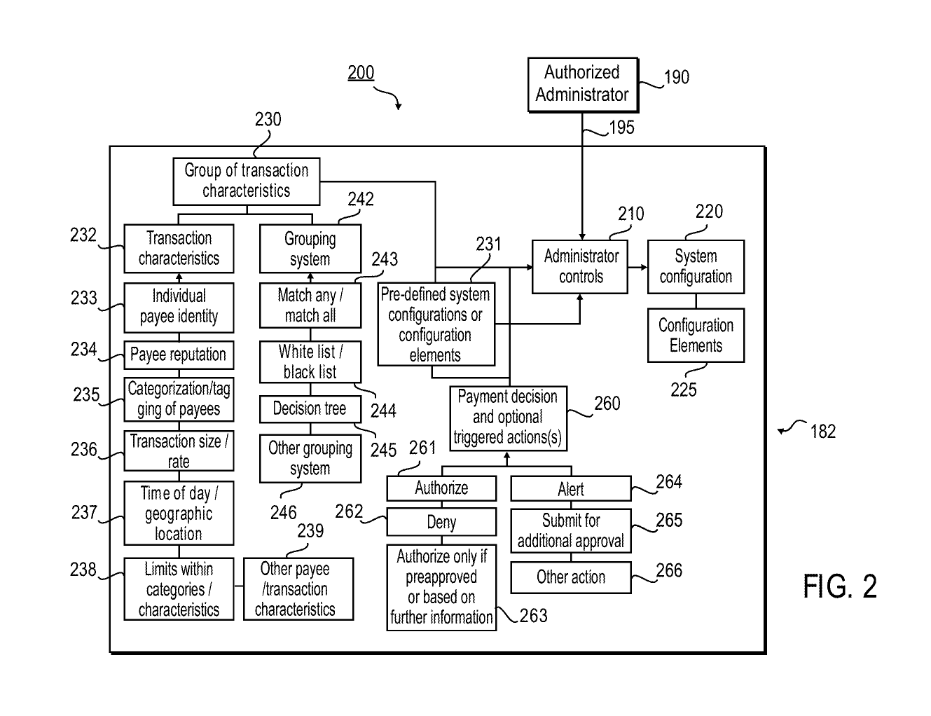

FIG. 2 illustrates the administrator control system 200 of the transaction control module 182. The authorized administrator 190 accesses the administrator control system 200 of the transaction control module 182 via the administrator controls 210. The authorized administrator 190 may be, for example, the payer, their trusted advisor, guardian, or parent, or another person. The authorized administrator 190 is authorized and authenticated to access the administrator controls 210 using any number of commonly available systems to authorize and authenticate a user of a system or apparatus. The purpose of the administrator controls 210 is to enable an authorized administrator 190 to create a system configuration 220, which is a list or set of configuration elements 225 set specifically for the individual payer.

The configuration elements 225 include two parts: a predetermined group of predetermined transaction characteristics and a predetermined payment decision and optional triggered action(s), set by the authorized administrator. The system configuration 220 pertains to one or multiple payers who are able to use the payment processing system. A payer may have multiple associated system configurations, for example, for a credit card issued by their workplace, which has one system configuration, and personal credit card issued by their bank with a different system configuration.

As shown in FIG. 2, the authorized administrator 190 uses the administrator controls 210 to select and define the configuration elements 225 from among a group of transaction characteristics 230 and payment decision and optional triggered action(s) 260. The authorized administrator 190 determines which of the group of transaction characteristics 230 and payment decision and optional triggered action(s) 260 will become the configuration elements 225 of the system configuration 220.

The group of transaction characteristics 230 includes one, or multiple, transaction characteristics 232 and a grouping system 242. The group of transaction characteristics 230 is a set of transactions attributes required for a transaction to be authorized. These transaction characteristics are collected and maintained for the purpose of determining whether a submitted payment request, which includes submitted transaction characteristic data specific to the transaction, matches the predetermined group of predetermined transaction characteristics set by the authorized administrator 190 as part of the system configuration 220. That is, when a payment request is submitted, the predetermined group of predetermined transaction characteristics determines whether the submitted payment request matches or does not match an allowable transaction.

A transaction characteristic is a recognizable attribute of a transaction, and as a configuration element 225 may have a value, set of values or range of values that are assessed in deciding whether to authorize the payment request. The submitted payment request includes a set of submitted transaction characteristics, which, for each characteristic, is most often a singular value, that is compared against the predetermined transaction characteristics in the system configuration 220. Through the administer controls 210, a predetermined transaction characteristic value or set or range of values may be created (for example, “enter the name of the store”) or selected (for example “pick a store from the list below,” or some combination thereof. Example transaction characteristics may include transaction characteristics in one or more of the following categories:
1. Individual Payee Identity 233—the range of values includes, for example, “Target®”, “Kroger®”, “Verizon Wireless®”, “Joe's Bookstore.”
2. Payee Reputation 234—reputation scores or evaluations may, for example, be derived or generated from a number of sources, for example, association membership or certification (Better Business Bureau, Diamond Certified®), external fraud notifications, or a list maintained within the payment decision and action system (described below) specifically for the purpose of evaluating payee reputation. For example a list in which users of the service can submit fraudulent or unethical sales practices which will affect the payee's reputation. Such a list may collect customer comments and evaluations over time so that the payment decision and action system can build a database or model, i.e. “learn,” the business reputation. Values may be on a numeric scale, grades, approved/disapproved, or other way of measuring or describing reputation.

3. Categorization/Tagging of Payees 235—values may include any tag or category matched to a payee by the system, for example, “Groceries,” “Bookstore,” “Sells Alcohol”, “Does Not Sell Alcohol”, “Pharmacy”, “Online Merchant.” This can include, for instance, the payee's business or type of business, the payee's industry, or on a business classification system created by, for instance, the government or other entity.
4. Transaction Size/Rate 236—for example, “under $20”, “more than once per week”, “over $200 in a single month.” This may include the number of transactions (which may include zero transactions) made with a payee over a certain amount of time, or the presence and volume (which may be zero) of transactions made in the past with the payee.
5. Time of Day/Geographic Location 237—for example, “after 9 pm”, “outside the Indianapolis area.”
6. Limits Within Categories/Characteristics 238—for example, you might set a monthly limit of four movie theater visits or $200 on meals in restaurants (which are both payee categories), or you could limit the amount of money spent with a particular payee, over a certain length of time.
7. Other Payee/Transaction Characteristics 239—for example, specific items that the payer is attempting to purchase via the transaction.

The grouping system 242 is a definition of how the predetermined transaction characteristics included in the system configuration 220 will be assessed against the submitted transaction characteristic data included in a submitted payment request, and is the method used to determine whether the submitted payment request matches the predetermined transaction characteristics. The grouping system may include one or more of the following:
1. Match Any 243—in a “match any” system, a transaction would be said to “match” if it has any of the predetermined transaction characteristics.
2. Match All 243—In a “match all” system, a transaction would be said to “match” if it has all of the predetermined transaction characteristics.
3. Black List 244—a “black list” system is used in other industries (for example, in prevention of unsolicited “spam” email) to allow any transaction (for example, delivery of an email) that does not match any of the identified characteristics (for example, the sender domain or relay being in a set of domains known to originate unsolicited email).
4. White List 244—A “white list” system is used to allow any transaction that does match any of a set of identified characteristics.
   “Black lists” and “white lists” are maintained both collectively (for example, by a service provider and applied to all its customers), and individually (for example, by a user). In this example, the payment decision and action system (described below) might maintain a “white list” of trusted payees and a “black list” of un-trusted payees, and users could individually add their own entries to a personal “white list” and “black list”.
5. Decision Tree 246—a decision tree can be represented, for example, with a flow-chart of YES/NO decision points rendering a decision MATCHES, or DOES NOT MATCH, or by defining the value of “matches” based on a boolean algebra statement of transaction characteristics, parenthesis, and AND/OR operators. These mechanisms are commonly used in other industries, for example to decide whether a database record matches a query.
6. Other Grouping System—any other system that can take a set of one or more predetermined transaction characteristics included in the system configuration 220 and produce a yes/no decision about whether a transaction matches and therefore should be allowable or not allowable.

The configuration elements 225 of the system configuration 220 also include predetermined payment decision and optional triggered action(s) that the authorized administrator 210 selects from the payment decision and optional triggered action(s) and includes in the system configuration 220 via the administrator controls 210.

The payment decision within the configuration element includes the following:
1. Authorize 261—allow the transaction to proceed, fulfilling the payment request by debiting the payer account and crediting the payee account.
2. Deny 262—do not allow the transaction to proceed.
3. Authorize Only if Preapproved Or Based On Further Information 263—require certain preapproval action(s) to have taken place in order for the transaction to be approved. For example, the transaction may be denied unless a trusted third party (a parent or guardian, for example) has been notified of the potential transaction and has specifically indicated that it is to be authorized. In another example, the request may be to the payee themselves—for example, on a computer terminal at the point of service, it might ask the cashier “does this purchase contain alcohol”, to which the cashier would have to answer “yes” or “no.” Or the system might be configured to automatically correspond with the point of service terminal to determine if any of the items purchased contained alcohol. The statement, submitted by the payee that the purchase was determined not to contain alcohol, would be considered a preapproval action.
   The system configuration must include authorize 261 and deny 262 decisions, one of which will be sent to the payee 150. However the authorize only if preapproved or based on further information 263 decision is something that the authorized administrator 190 can choose to add, and, if added, requires additional configuration to include preapprovals and/or what further information is required. The further information required may also be automatically added based on the transaction characteristics 232 and grouping system 242 chosen by the authorized administrator 190.

An optional triggered action is an action initiated by the transaction control module 182 in response to processing of the submitted transaction characteristics data. A triggered action may include one or more of the following:
1. Alert 264—Notify one or more parties of the transaction, for example by logging it, sending an email or text message, or another form of alert.
2. Submit for Additional Approval 265—Request preapproval action(s) through a notification or request system, for example sending a text message describing the transaction, and requesting that the recipient text back “yes” or “no,” or using a push notification in a mobile application to enable a third party to click “yes” or “no”. Or, request further information from the payee or the payer or another third party—for example if not enough submitted transaction characteristics data are present to determine whether the transaction should go through
3. Other Action 266—which may be controlled by the authorized administrator 190.
   None of the triggered actions are required for operation of the payment processing system. However, the authorized administrator may include them in the system configuration 220 and customize alerts and triggers based on needs.

There are three methods that the authorized administrator 190 may use to create the system configuration 220. First, the authorized administrator 190 may create configuration elements 225 individually, and compose them into a set or list, thereby creating a system configuration 220. Second, as shown in FIG. 2, the administrator controls 210 may also access and optionally pre-edit configuration elements from a list or database of predefined configuration elements 231, to make configuration simple. Finally, and simplest, the authorized administrator may chose a completely pre-defined system configuration 231.

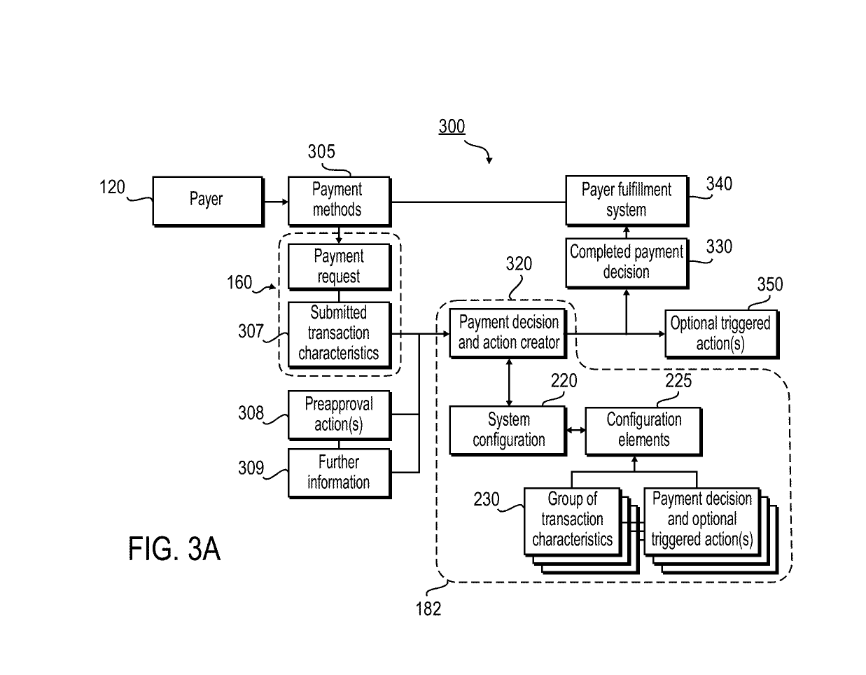

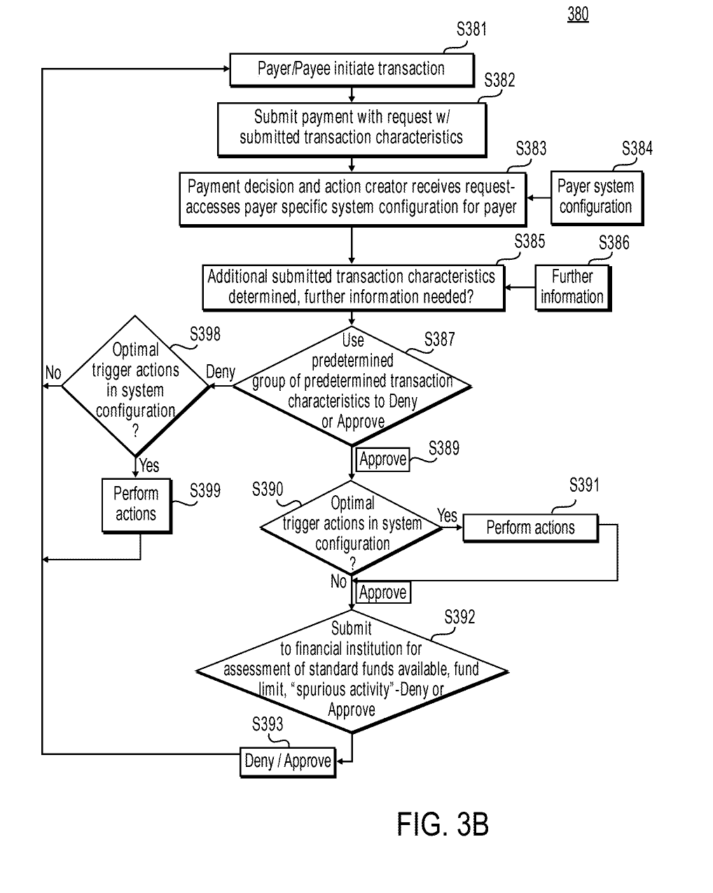

FIG. 3A is a chart 300 illustrating details of the payment processing system 100 shown in FIG. 1. FIG. 3 shows payer 120 in the process of making a payment to a payee (not shown in FIG. 3), which is typically as a tender for goods and services. To make the payment, the payer 120 using the payment processing system uses a cashless payment method 305 to make the payment. The cashless payment method 305 may be a credit card point of service, a debit card point of service, the acceptance of a check, an online system such as PayPal, a mobile payment system such as Google Wallet, or any of a number of other commonly available cashless payment methods.

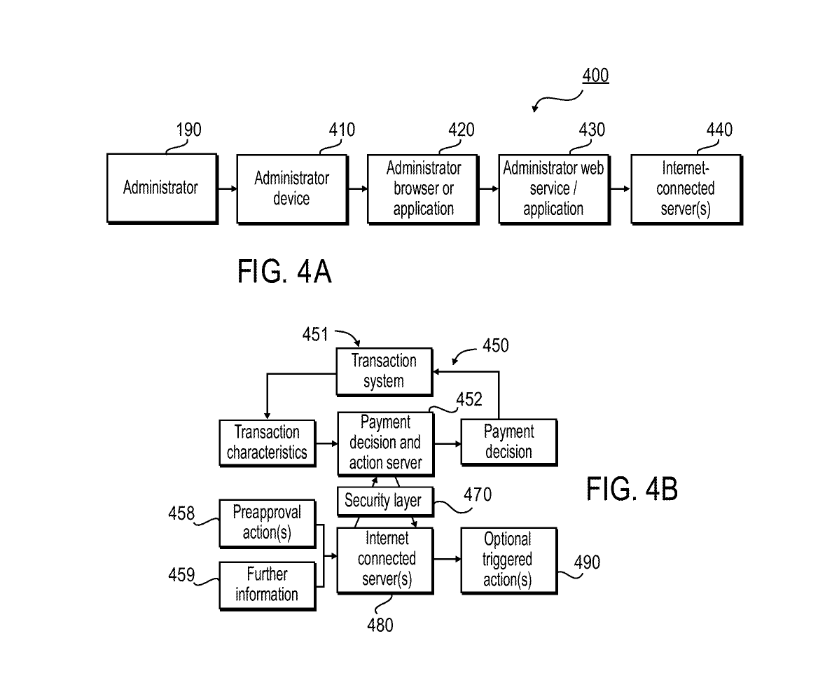

The payment method 305 is used by the payee to create and submit a payment request 160. The cashless payment method 305 uses a payment device, such a credit card, check or account number, to transfer payer information into a transaction system (described below with respect to FIG. 4B) with the submitted payment request. The submitted payment request may be a physical object, such as via a check or wire transfer instructions, or data objects, such as a credit card approval request sent electronically over a secure data network to the financial institution.

When the payment method is in operation, it creates a submitted payment request 160. The payment request 160 includes a set of submitted transaction characteristics with specific values for the transaction, which may be chosen from the range or set of possible values for that transaction, and includes transaction characteristics data necessary for the transaction control module 182 to assess the transaction using the system configuration 220, including the predetermined transaction characteristics included as part of the configuration elements 225 set by the authorized administrator 190. The submitted transaction characteristic data may, for example, include the individual payee identity for the transaction, the time of day, geographic location, the amount of the purchase, the items being purchased etc. Such data may then be used to obtain, by looking up or calculating, other submitted transaction characteristics needed to assess the transaction. For example, using the payee identity, the payee reputation may be looked up, for instance in a look up table, and also the payee category (i.e., groceries, sporting goods, medical equipment, etc.) may be determined. In another example, using the payment amount and the payee category, a rate of payment amount per category for a give time period may be calculated. The submitted payment request 160 including submitted transaction characteristics data is input into the transaction control module 182.

In addition to the payment request 160, zero, one or more preapproval actions 308 may have occurred before the payment request 160 was submitted, or in the course of it being submitted. For example, before the payer enters the grocery store, the payer may have alerted the trusted third party (i.e., the authorized administrator), that he was intending to shop for groceries. The alert may have occurred either through a conscious effort or through a geographic or proximity mechanism that automatically created the alert. Through operation of the system (for example by clicking a button on a computer interface or sending a text message via a cell phone), the third party may have engaged in a required pre-approval action 308, and the pre-approval information is sent to the transaction control module 182.

The payment decision and action creator 320 receives a submitted payment request 160 and identifies its submitted transaction characteristic data, or is able to receive sets of transaction characteristic data alone. The payment decision and action creator 320 is also able to receive zero or more types of preapproval action(s) 308. For example, when the payment method is used to submit a payment request to a financial institution for processing, the financial institution's data processing system may send the payment request 160 electronically to the payment decision and action creator 320. For another example, the payment decision and action creator 320 may have an internet-connected component that is activated by a mobile device user who clicks a button on their mobile device, constituting a pre-approval action 308 which may be stored or input directly into the payment decision and action creator 320.

As will be discussed in more detail below with respect to FIG. 5, in one of many possible embodiments of the invention, the payment decision and action creator 320 is connected to, or part of, a data processing system (not shown in FIG. 3) at a payer's financial institution, and when a credit card or debit transaction is used to submit a payment request, the data processing system may first check that there are sufficient funds, and, if so, the payment request is input into the payment decision and action creator 320 and the authorize/deny decision is made there and sent back to the credit card network. In another embodiment, the credit card or debit card network first screens a payment request submitted by a payee in the payment decision and action creator 320, and then submits the payment request to the payee's financial institution only if it is authorized by the payment decision and action creator.

When the payment decision and action creator 320 receives a set of submitted transaction characteristics with a payment request, it uses the system configuration 220 that pertains to that payer and payment method. For zero, one, or more of the configuration elements in the set or list of configuration elements 225 included by the authorized administrator 190 the system configuration 220, it determines if the payment request is a “match” based on the predetermined group of predetermined transaction characteristics. The final item in a list of configuration elements may be a “default option” if such an option is specified.

If the payment decision and action creator 320 completes the assessment between the submitted transaction characteristics 307 and the predetermined group of predetermined transaction characteristics included as configuration element 225, the payment decision and action creator 320 activates the other part of the configuration element 225: the payment decision and triggered actions 260.

Based on the predetermined payment decision and triggered actions present in the configuration element 225, the payment decision and action creator 320 then creates objects (either data objects or, in some cases, physical objects). One object is a completed payment decision 330, which (either prima facie or based on the presence or absence of any preapproval action(s) 308 or further information 309 requested or submitted by the payee, the payer, or another party) is either “Authorize” or “Deny.” The predetermined payment decision and optional triggered actions included in the configuration elements 225 may also result in zero, one, or more than one triggered action(s) 350.

The payment decision and action creator 320 then sends the completed payment decision 330 (for example, a data object representing the approval or denial of a credit card transaction, or a physical stamp on a check) to the payer fulfillment system 340. The payer fulfillment system 340 is a system or apparatus able to send the completed payment decision 330 to the services of the payment method 305. An example of a payer fulfillment system 340 is the computer system at a financial institution that sends “approved” or “denied” via a credit card data network to a credit card point of service.

Through the operation of the payment processing system, therefore, the request for payment is either halted or allowed to proceed. In a typical example, the payment is either tendered or not tendered, and the goods or services are either provided or not provided on that basis.

The payment decision and action creator 320 is also able to create physical or data objects representing zero, one, or more triggered action(s) 350 present in the configuration elements 225. Examples of triggered action(s) 350 may be a physical letter notifying a designated recipient of a transaction, or a text message, email, or logged record of the transaction.

FIG. 3B is a flow chart illustrating an example embodiment of a process 380 used by the payment processing system. In Step S381, the payer initiates a transaction with the payee. The payee in S382 submits the payment request with the submitted transaction characteristics. In S383, the payment decision and action creator 320 receives the request for payment. Using the information in the submitted transaction characteristics that identify the payer and, optionally, the specific payer account, the payment decision and action creator accesses the specific payer system configuration 384. Using the specific payer system configuration 384, the payment decision and action creator at S385 determines if additional submitted transaction characteristics are needed, and if so, either determines (via look-up or calculation) the additional submitted transaction characteristics and/or requests further information, from, for instance, payer, payee or authorized administrator, or a fourth party (e.g. the Better Business Bureau).

The payment decision and action creator 320 then S387 uses the predetermined group of predetermined transaction characteristics for the payer (which are payer configuration elements in the payer's system configuration) to determined whether to Deny or Approve the transaction. If the transaction is denied S388, the payee is provided that information. If the transaction is either denied or approved, the payment decision and action creator 320 determines if there are predetermined optional trigger actions 390/398 included in the payer's system configuration, and, if so, those actions 391/399 are performed. If in S390 an approval is received from S387, then, the payment request is submitted to the payer's financial institution for a check of standard fund available, fund limits and “suspicious activity” and a deny or approve decision, which is communicated S393 to payer/payee. A decision to deny a payment request may be “communicated” to the payer/payee by the payer/payee receiving no communication that the payment request is approved. That is, when a payment request is denied, if, after a certain amount of time, the payer and/or payee do not receive an indication that the payment request is approved, then the denial is communicated. As discussed below with respect to FIG. 5, the position of S392 in the process flow may be modified.

The physical apparatus for operation of the payment processing system is shown in FIGS. 4A and 4B and includes two parts. They payment processing system is implemented in one or more data processing machines, e.g., a computer processor, using software to perform the method. The first part, shown in FIG. 4A, is an apparatus 400 for the administrative control system 200. The second part, shown in FIG. 4B, is the apparatus 450 for making the transaction decision.

In general, various example embodiments described herein include methods and techniques. However, the invention may also cover an article of manufacture that includes a non-transitory computer readable medium on which computer-readable instructions for carrying out embodiments of the method are stored. The computer readable medium may include, for example, semiconductor, magnetic, electromagnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable hardware circuits (such as electrical, mechanical, and/or optical circuits) adapted for the various operations pertaining to embodiments of the invention.

FIG. 4A illustrates a physical embodiment 400 of the administrator control system 200. The authorized administrator 190, an authorized individual, uses an administrator device 410 to interact with a browser (e.g. Internet Explorer®, Firefox®) or a purpose-built application 420. The administrator device 410 may be, for example, as a mobile phone, tablet, netbook, terminal, or personal computer. The browser or application 420 sends data to and from a web service or web application 430. The web service or web application runs on a server 440. A server 440 may be a physical machine, several physical machines, a virtual server, or a group of virtual servers, each comprising operably connected computer processor(s) (i.e., data processing machines), persistent and transient data storage capability, and the ability to receive and transmit data, and optionally comprising other capabilities and components, e.g. load balancers, firewalls, routers, etc. The server(s) 440 host the administrator controls 210. Web services, software applications, or web applications give the authorized administrator a set of prompts or descriptions requesting information of various types, transmits those responses to a server, and creates or modifies stored data objects based on the data transmitted. This apparatus, so described and operated, is therefore able to create stored data objects representing system configurations 220 defined by the administrator.

When the payer initiates a transaction with the payee and the payee submits a request for payment, the second part of the apparatus 450, shown in FIG. 4B, for making payment decisions is operated.

The payment processing system is utilized via a transaction system 451. The transaction system 451 is used in conjunction with the payment method 305 and is an apparatus able to either receive or generate transaction characteristics data, in some cases to transmit transaction characteristics data, and is able to either receive or generate transaction decisions, and is able to transmit transaction decisions. The transaction system may be, for example, a POS system, a network system, a financial institution system, a hybrid apparatus, or some combination of these. Any system with the capabilities described may be used as the transaction system.

A POS system includes an apparatus able to gather information about the amount requested by the payer and gather and/or store information about the payer's method of payment. Examples of POS systems are credit card swipe systems, online billing systems, proximity readers, mobile payment systems, app stores, or debit card machines. These systems then transmit the amount requested and the payee method of payment to a network for fulfillment. The network then sends back whether the transaction was approved or denied, which is received by the POS system and then transmits that to the payer and/or payee, e.g., the decision is displayed onscreen at the website, on the ATM or credit card terminal screen, or on a receipt printed by the machine.

A network system includes a set of communication channels and computers that route transaction data including payment details and requested payment amount from POS systems to financial institution systems, and route the approved/denied action back to the POS system. Examples of this include credit card networks (e.g., VISA® network) and ATM networks (e.g. PULSE® ATM networks), ACH, etc.

A financial institution system includes an apparatus that receives the proposed transaction, decides whether to fulfill it (e.g. from a depository account or line of credit) based on a limited number of factors (would the transaction exceed the balance or limit, and is the transaction suspicious) and sends back an approval decision.

A hybrid apparatus, such as PayPal, may include, at times, a POS system (e.g. in a web browser), a financial institution (with its own prepaid balance), and/or a network (submitting payment details to the financial institution).

A payment decision and action server 452 is connected to the transaction system 451. Payment decision and action server 452 is a physical machine, several physical machines, a virtual server, or a group of virtual servers, each comprising operably connected computer processor(s) (i.e., data processing machines), persistent and transient data storage capability, and the ability to receive and transmit data, and optionally comprising other capabilities and components, e.g. load balancers, firewalls, routers, etc. The payment decisions and action server 452 may run the software application for transaction control module 182 and includes the payment decision and action creator 320 and includes the system configuration module 220 having the configuration elements 225 set by the authorized administrator 190.

The payment decision action server may be connected as part of the payment processing system at different points, as illustrate in FIG. 5.

FIG. 5 depicts the typical elements of a transaction between payer 120 and payee 150, and the places where, in various embodiments, the payment decision action server 452 could be installed in order to operate. FIG. 5 illustrates the payer/payee 120/150 submitting a payment request 160 via a POS system 551 as the transaction system. The submitted payment request includes submitted transaction characteristics 307. Data is transferred between the POS system 551 and the financial institution system 170 via a data network 556. The financial institution system 170 includes data processing machines 180 that, among other things, determine whether the payment request has sufficient funds or is a “suspicious activity.”

The payment decision and action server 452 may be connected at the point indicated with a 1 (Point 1). In this case, the submitted transaction characteristics data is input directly into the payment decision and action server 452. If the payment decision action server 452 returns a Deny, the POS system transmits back Deny to payer/payee 120/150, otherwise it transmits the transaction characteristics to the Network 556. Likewise, the payment decision action server 452 may be attached at Point 2 to the network system 556, which transmits back a Deny to payer/payee 120/150 through the network system 556, or transmits the payment request to the financial institution 170. When the payment decision action server 452 is attached at Point 3 it can render an Approve/Deny decision that either passes the so-far-OK'ed transaction to the balance, limit, and suspicious activity checks 181 already performed by the financial institution system 170, or route a Deny decision directly back to the network 556. When the payment decision action server 452 is attached at Point 4 to the financial institution system it is connected immediately before passing the payment decision to the network 556. Point 5 illustrates attaching it to the Network, and Point 6 illustrates attaching it to the Point of Service system, both after approval or deny based on the financial institution systems set requirements in 181. Thus, position of the payment decision and action server 452 within the payment processing system results in either the payment decision and action server 452 making the first Approve/Deny decision or the financial institutions standard check 181 making the first Approve/Deny decision, with Deny decisions being sent back to the payee/payer 150/120 and Approve decisions moving the payment request to the next decision point (either the financial institutions standard check 181 if the payment decision and action server 452 made the first request or vice versa).

Returning to FIG. 4B, the second part 450 also includes apparatus for preapproval actions, further information, and triggered actions. In some cases, no preapproval actions, further information, and optional triggered actions are included. If preapproval actions, further information, and optional triggered action(s) are included, the part of the apparatus enabling their operation is as follows.

Any preapproval action(s) 458 (308 of FIG. 3) and/or further information 459 (309 of FIG. 3) is/are gathered. The method and apparatus for gathering, transmitting, and storing these data depend on the types of data being gathered. For example, it may involve a software program on the payee's mobile device or proximity device carried near the payee transmitting the payee's location to the system; it may involve a text-message, email, pull, or push notification to a third party's mobile device, etc. In many cases, these will be requested by and/or sent to an internet-connected server 480. This server may be the same server or a different server than the Payment Decision and Action Server 452.

The apparatus 450 may have a security layer 470 between the internet-connected server(s) 480 and other components. Security layers come in many forms, may be present on a single server or between servers, and are common throughout apparatuses that communicate with the Internet—this layer is highlighted specifically because financial institutions are often very sensitive about internet-connected servers communicating with their financial systems, so security at this stage may be particularly important; but there may or may not be an extra security layer here, and security layers may be present in multiple other areas of the apparatus and system.

The data representing any preapproval actions and further information are transmitted from the internet-connected server 480 to the payment decision and action server 452 (if the two are not on the same server). Then, when the payment decision and action server 452 makes its payment decision, data requiring any optional triggered actions is transmitted back to the internet-connected servers 480 (if the two are not the same server).

The method of triggering the additional actions 490 depends on the actions. For example, if they involve creating a text message or email, data representing those objects would be sent to an email server or a text-message service.

### Example of Use

In one hypothetical example of the payment processing system in use is as follows. An adult daughter will be caring for her aging mother. The daughter will use a set of online tools, that include that administrator controls 210 to create the system configuration 220, provided by her mother's bank to specify that credit card transactions for medical care, groceries, transportation, and entertainment under $50 will be approved unless they are on a blacklist of merchants with unethical marketing practices. When her mother goes shopping for groceries, her credit card transactions will be approved. But when an unethical merchant calls her and convinces her to purchase an expensive set of hearing aids that she does not need and cannot afford, the transaction will be denied and a text-message alert will be sent to her daughter.

In another hypothetical example, an alcohol addict (or their sponsor or family member) could set up a credit or debit card that will deny any transaction to a payer that sells alcohol, or will deny transactions within hours during which they typically consume alcohol. The same could help those who suffer from impulsive or compulsive shopping, snacking, gambling, or any of a range of other undesired behaviors

In another hypothetical example, a parent of a student, or guardian for an elderly person, could configure a credit card that will work for food, books, transportation, and other predefined categories of expenses, but does not allow other types of expenses unless they are preapproved by the parent or guardian.

In another hypothetical example, a corporate manager could configure a payment card that will be usable for conswner goods, designed to cover specific types of expenses or amounts—for example, office supplies and/or meals under $25.

1. A computer-implemented method of processing transactions initiated by a payer, comprising:
providing administrative control that enables an administrator to specify predetermined transaction characteristics to be applied to subsequent electronic transactions;
storing the predetermined transaction characteristics electronically;
receiving an electronic payment authorization request submitted by a payee, the payment authorization request associated with a subsequent transaction initiated by the payer and having a set of submitted transaction characteristics;
comparing the set of submitted transaction characteristics against the predetermined transaction characteristics;
sending an approval or a denial of the payment authorization request to a payer fulfillment system on the basis of at least the results of the comparison.

2. The computer-implemented method of claim 1, further comprising electronically prompting a guardian for preapproval of the payment authorization request, wherein the guardian is specified as part of the administrative control.

3. The computer-implemented method of claim 2, wherein the denial of the payment authorization request is sent in response to a determination that the set of submitted transaction characteristics do not match the predetermined transaction characteristics and no preapproval is received from the guardian.

4. The computer-implemented method of claim 2, wherein the approval of the payment authorization request is sent in response to a determination that the set of submitted transaction characteristics do not match the predetermined transaction characteristics but a preapproval is received from the guardian.

5. The computer-implemented method of claim 1, wherein the approval of the payment authorization request is sent in response to a determination that the set of submitted transaction characteristics matches the predetermined transaction characteristics.

6. The computer-implemented method of claim 1, wherein the denial of the payment authorization request is sent in response to a determination that the set of submitted transaction characteristics do not match the predetermined transaction characteristics.

7. The computer-implemented method of claim 1, wherein the predetermined transaction characteristics include at least one of payee name, payee reputation, payee category, sale item category, number of transactions made by payer with the payee, amount of money spent by payer with the payee over a given period of time, geographic location of payee, geographic location of initiation of the payment transaction, and category limits.

8. The computer-implemented method of claim 1, wherein the administrative control is provided to a third party other than the payer.

9. The computer-implemented method of claim 1, wherein the electronic transaction is a credit card or PayPal transaction.

10. The computer-implemented method of claim 1, further comprising electronically notifying the payee to request additional information.

11. The computer-implemented method of claim 10, wherein electronically notifying the payee to request additional information includes querying for a response to whether the transaction associated with the payment authorization request pertains to a certain product or product type specified in the predetermined transaction characteristics.

12. The computer-implemented method of claim 2, wherein electronically prompting a guardian for preapproval of the payment authorization request includes:
sending a text message describing the transaction, and
requesting that the recipient text back “yes” or “no.”
